(19) United States
(12) Patent Application Publication
(10) Pub. No.: US 2025/0269504 A1
(43) Pub. Date: Aug. 28, 2025

(54) ENGAGING STRUCTURE FOR HAND TOOL

(71) Applicant: Yu-Ping Tsai, Taichung (TW)

(72) Inventor: Yu-Ping Tsai, Taichung (TW)

(21) Appl. No.: 18/587,688

(22) Filed: Feb. 26, 2024

(51) Int. Cl. B25B 23/10; B25B 13/04; B25B 13/06; B25B 13/46

(52) U.S. Cl. CPC B25B 23/105; B25B 13/04; B25B 13/065; B25B 13/462

(57) ABSTRACT

An engaging structure for a hand tool includes a main body provided with a mounting element having six drive portions and six receiving portions. Each of the drive portions includes a first face, a second face, and a third face. A first intersection point is located at an intersection of the first face and the second face. A second intersection point is located at an intersection of the first face and the third face. Each of the receiving portions is an arcuate concave face. The mounting element has a first hexagon. The first face of each of the drive portions coincides with each of the sides of the first hexagon. The first hexagon has six first angled corners. The first arc of each of the six receiving portions is situated outside of each of the six first angled corners.

### BACKGROUND OF THE INVENTION

### Field of the Invention

The present invention relates to a hand tool and, more particularly, to an engaging structure for a hand tool.

### Description of the Related Art

A conventional socket structure was disclosed in the U.S. Publication No. 2007/0125204, and comprises a socket 20 having an engaging hole 22, six grooves 23, and six stop ribs 24.

However, such a conventional socket structure has the following disadvantages.

1. When the socket 20 drives the screw head 40, the stop ribs 24 are locked on the six sides of the screw head 40, to rotate the screw head 40. The stop ribs 24 protrude in the engaging hole 22 to an extent, and a large interval is defined between the groove 23 of the engaging hole 22 and the angled corner of the screw head 40 so that the engaging hole 22 cannot easily rub the angled corner of the screw head 40. But, the socket 20 needs to have a determined thickness to keep the rotation force and torque, so that the outer diameter of the socket 20 is increased due to projection of the stop ribs 24.

2. Each of the stop ribs 24 has a sharp pointed shape so that the rotation torque is not large enough. Thus, the screw head 40 is easily worn out or chamfered by the stop ribs 24 during a period of time.

3. When the socket 20 is used to rotate the screw head 40, the stop ribs 24 engage the screw head 40 successively and easily cause a serration on the screw head 40.

### BRIEF SUMMARY OF THE INVENTION

In accordance with the present invention, there is provided an engaging structure for a hand tool comprising a main body. The main body is provided with a mounting element. The mounting element includes six drive portions and six receiving portions. Each of the six drive portions includes a first face, a second face, and a third face. A first intersection point is located at an intersection of the first face and the second face. A second intersection point is located at an intersection of the first face and the third face. Each of the six receiving portions is an arcuate concave face. Each of the six receiving portions is formed with a first arc. The mounting element has a first center, a first circle, and a first hexagon. The first face of each of the six drive portions coincides with each of the six sides of the first hexagon. The first center is provided with a first vertical line. The first vertical line passes through the first intersection point. The first hexagon has six first angled corners. The first arc of each of the six receiving portions is situated outside of each of the six first angled corners.

According to the primary advantages of the present invention, the main body is rotated clockwise to screw the screw member by a large area contact of the second face. Alternatively, the main body is rotated counterclockwise to unscrew the screw member by a large area contact of the third face. Alternatively, the main body is rotated counterclockwise to unscrew the worn screw member by a force concentration of the second intersection point. Thus, the mounting element has three rotational modes to drive and rotate the screw member.

According to another advantage of the present invention, each of the six receiving portions is an arcuate concave face. Each of the six receiving portions is arranged between the second face of one of the six drive portions and the third face of another one of the six drive portions. Each of the six receiving portions is formed with a first arc. The first arc is not tangent to the second face and the third face. Thus, when the main body is rotated to drive the screw member, each of the six angled corners of the screw member is received in each of the six receiving portions, thereby preventing each of the six angled corners of the screw member from being worn out.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an engaging structure for a hand tool in accordance with the first preferred embodiment of the present invention.

FIG. 2 is a front view of the engaging structure for a hand tool in accordance with the preferred embodiment of the present invention.

FIG. 3 is a schematic front view of the engaging structure for a hand tool in accordance with the preferred embodiment of the present invention.

FIG. 4 is a front view of a first operation state of the engaging structure for a hand tool in accordance with the preferred embodiment of the present invention.

FIG. 5 is a front view of a second operation state of the engaging structure for a hand tool in accordance with the preferred embodiment of the present invention.

FIG. 6 is a front view of a third operation state of the engaging structure for a hand tool in accordance with the preferred embodiment of the present invention.

FIG. 7 is a perspective view of an engaging structure for a hand tool in accordance with the second preferred embodiment of the present invention.

FIG. 8 is a perspective view of an engaging structure for a hand tool in accordance with the third preferred embodiment of the present invention.

FIG. 9 is a perspective view of an engaging structure for a hand tool in accordance with the fourth preferred embodiment of the present invention.

FIG. 10 is a perspective view of an engaging structure for a hand tool in accordance with the fifth preferred embodiment of the present invention.

### DETAILED DESCRIPTION OF THE INVENTION

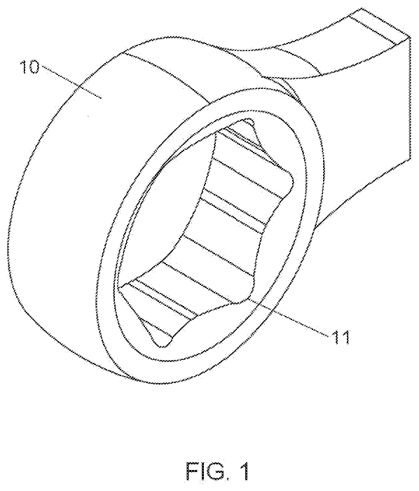

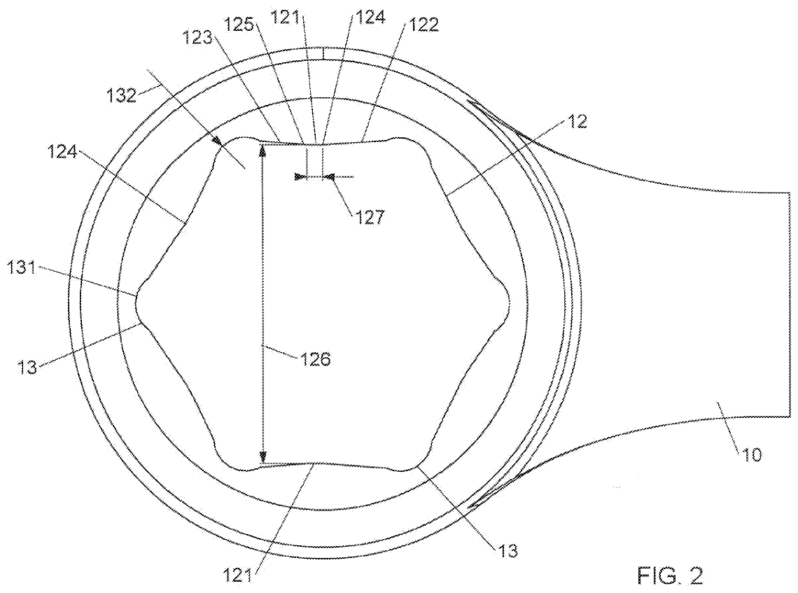

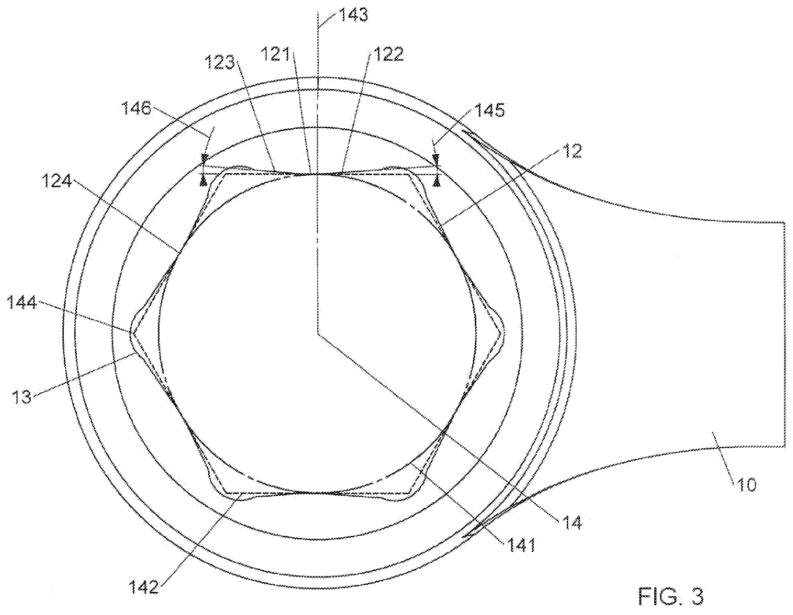

Referring to the drawings and initially to FIGS. 1-3, an engaging structure (or an operating structure or a driving structure) for a hand tool in accordance with the preferred embodiment of the present invention comprises a main body 10. The main body 10 is provided with a mounting element 11. The mounting element 11 includes six drive portions 12 and six receiving portions 13. The six drive portions 12 and the six receiving portions 13 are arranged alternately and annularly. The main body 10 is a box end wrench or an engaging member of a hand tool.

Each of the six drive portions 12 includes a first face 121, a second face 122, and a third face 123. The first face 121 is arranged between the second face 122 and the third face 123. Each of the first face 121, the second face 122, and the third face 123 has a planar shape. A first intersection point 124 is located at an intersection of the first face 121 and the second face 122. A second intersection point 125 is located at an intersection of the first face 121 and the third face 123. A first distance 126 is defined between two parallel first faces 121. A second distance 127 is equal to a length of the first face 121. The second distance 127 is defined between the first intersection point 124 and the second intersection point 125. The second distance 127 is one twentieth of the first distance 126.

Each of the six receiving portions 13 is an arcuate concave face. Each of the six receiving portions 13 is arranged between the second face 122 of one of the six drive portions 12 and the third face 123 of another one of the six drive portions 12. Each of the six receiving portions 13 is formed with a first arc 131. The first arc 131 is not tangent to the second face 122. The first arc 131 is not tangent to the third face 123. The first arc 131 has a first radius 132 which is one tenth of the first distance 126 and is two times of the second distance 127.

In a two-dimensional view, the mounting element 11 has an axis provided with a first center 14 which constructs a first circle 141. The first face 121 of each of the six drive portions 12 is tangent to the first circle 141. The first circle 141 forms a first hexagon 142 having six sides. The first face 121 of each of the six drive portions 12 coincides with each of the six sides of the first hexagon 142. The first center 14 is provided with a first vertical line 143. The first vertical line 143 passes through the first intersection point 124. The first face 121 and the third face 123 are located at a first side of the first vertical line 143, and the second face 122 is located at a second side of the first vertical line 143.

The first hexagon 142 has six first angled corners 144. The first arc 131 of each of the six receiving portions 13 is situated outside of each of the six first angled corners 144. A first angle 145 is defined between each of the six sides of the first hexagon 142 and the second face 122. The first angle 145 is ranged between four degrees and five degrees) (4°-5°. A second angle 146 is defined between each of the six sides of the first hexagon 142 and the third face 123. The second angle 146 is more than the first angle 145. The value of the second angle 146 minus that of the first angle 145 is ranged between 0.5 and 1.5. Preferably, the value of the second angle 146 minus that of the first angle 145 is ranged between 1.0 and 1.5.

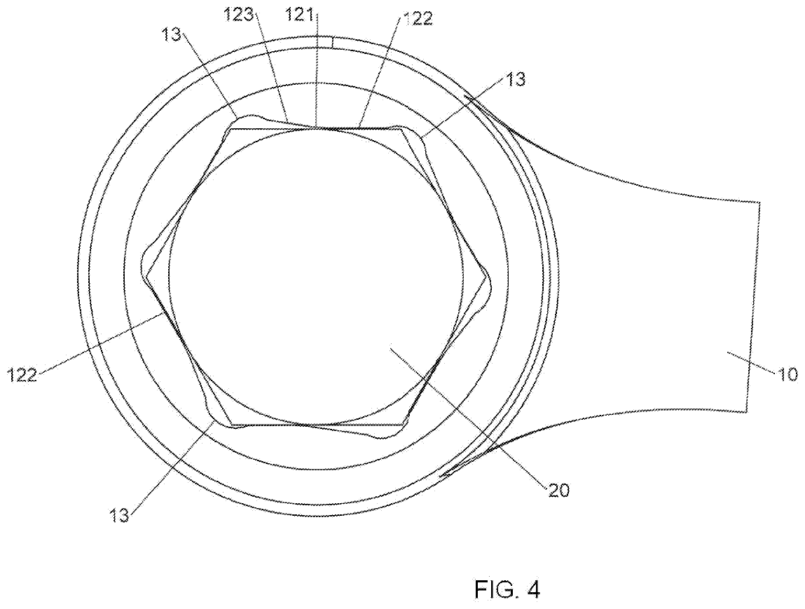

Referring to FIG. 4 with reference to FIGS. 1-3, the main body 10 is used to operate and rotate a screw member 20 having six sides and six angled corners. When the main body 10 is rotated clockwise to drive the screw member 20, the second face 122 of each of the six drive portions 12 rests on each of the six sides of the screw member 20, a space (or an interval) is defined between the third face 123 of each of the six drive portions 12 and each of the six sides of the screw member 20, and each of the six angled corners of the screw member 20 is received in each of the six receiving portions 13. Thus, when the main body 10 is rotated clockwise relative to the screw member 20, each of the six receiving portions 13 is spaced from each of the six angled corners of the screw member 20, to prevent each of the six angled corners of the screw member 20 from being worn.

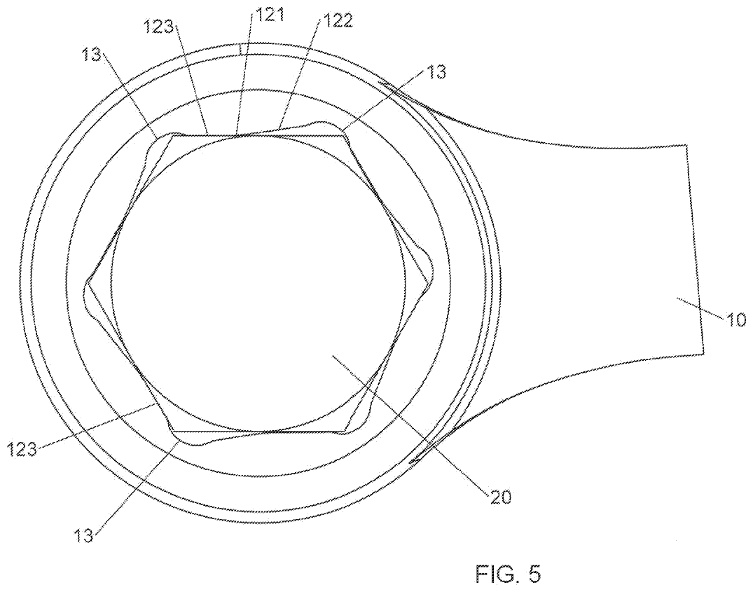

Referring to FIG. 5 with reference to FIGS. 1-3, when the main body 10 is rotated counterclockwise to drive the screw member 20, the third face 123 of each of the six drive portions 12 rests on each of the six sides of the screw member 20, a space (or an interval) is defined between the second face 122 of each of the six drive portions 12 and each of the six sides of the screw member 20, and each of the six angled corners of the screw member 20 is received in each of the six receiving portions 13. Thus, when the main body 10 is rotated counterclockwise relative to the screw member 20, each of the six receiving portions 13 is spaced from each of the six angled corners of the screw member 20, to prevent each of the six angled corners of the screw member 20 from being worn.

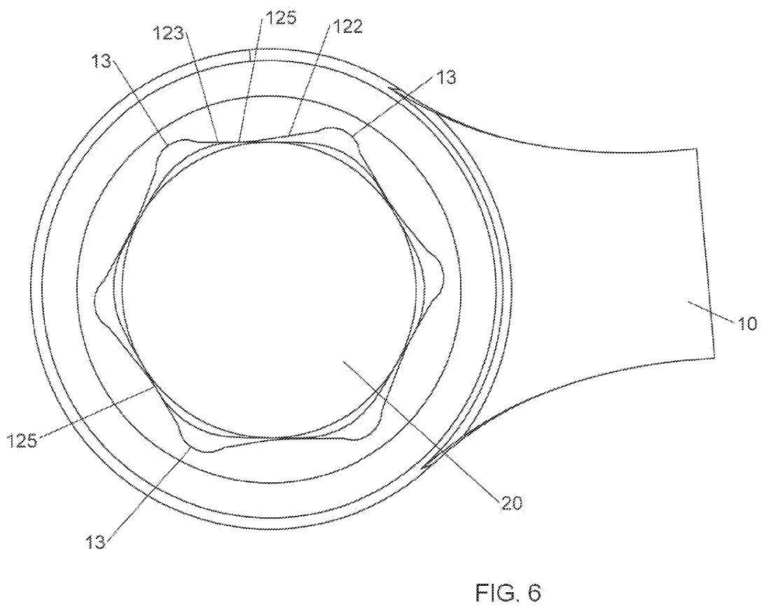

Referring to FIG. 6 with reference to FIGS. 1-3, the screw member 20 is worn out and rounded. When the main body 10 is rotated counterclockwise to drive the screw member 20, the third face 123 and the second intersection point 125 of each of the six drive portions 12 rest on each of the six sides of the screw member 20. In such a manner, the second intersection point 125 has a linear contact with and concentrates a force on the screw member 20 to drive the screw member 20. Thus, the mounting element 11 is used to drive and rotate the screw member 20 that is worn.

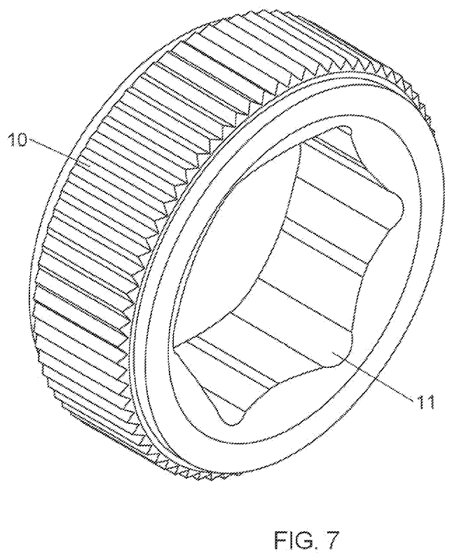

Referring to FIG. 7, the main body 10 is a ratchet wheel structure pivotally mounted on a ratchet wrench.

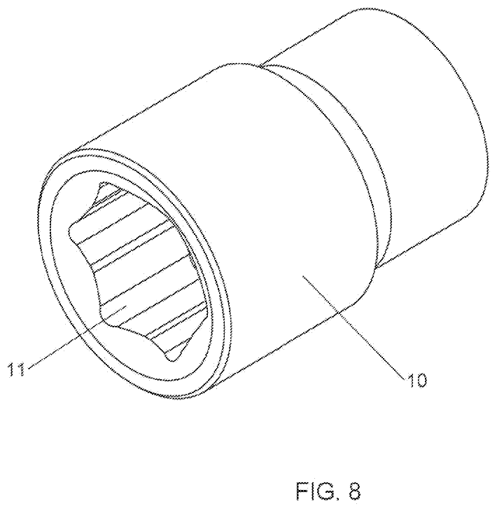

Referring to FIG. 8, the main body 10 is a socket structure.

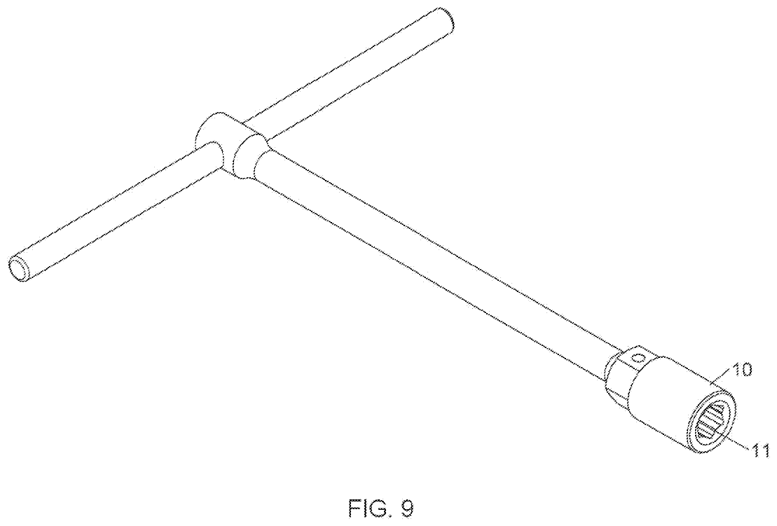

Referring to FIG. 9, the main body 10 is a sliding rod structure.

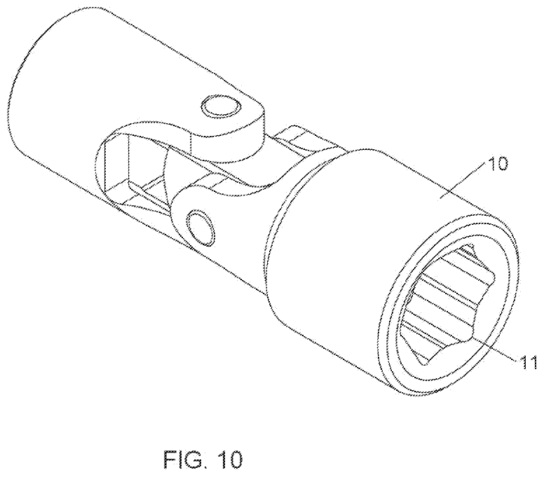

Referring to FIG. 10, the main body 10 is a float connector or a universal connector or a T-shaped universal connector.

In another preferred embodiment of the present invention, a fillet (or round corner) is formed between each of the six receiving portions 13 and the second face 122 of each of the six drive portions 12, so that each of the six receiving portions 13 and the second face 122 of each of the six drive portions 12 are connected smoothly. A fillet (or round corner) is formed between each of the six receiving portions 13 and the third face 123 of each of the six drive portions 12, so that each of the six receiving portions 13 and the third face 123 of each of the six drive portions 12 are connected smoothly. The second distance 127 is one tenth of the first distance 126. Thus, the first radius 132 is equal to the second distance 127.

Accordingly, the engaging structure for a hand tool of the present invention has the following advantages.

1. With reference to FIG. 4, when the main body 10 is rotated clockwise to drive the screw member 20, the second face 122 of each of the six drive portions 12 provides a primary force, and the first face 121 of each of the six drive portions 12 provides a secondary force. Thus, the second face 122 has the maximum contact area with the screw member 20, to prevent the six sides of the screw member 20 from being worn out.

2. With reference to FIG. 5, when the main body 10 is rotated counterclockwise to drive the screw member 20, the third face 123 of each of the six drive portions 12 provides a primary force, and the first face 121 of each of the six drive portions 12 provides a secondary force. Thus, the third face 123 has a larger contact area with the screw member 20, to prevent the six sides of the screw member 20 from being worn out.

3. With reference to FIG. 6, when the screw member 20 is worn out and rounded, the second intersection point 125 of each of the six drive portions 12 is locked on each of the six sides of the screw member 20. Thus, the second intersection point 125 of each of the six drive portions 12 applies and focuses a force on the screw member 20 to effectively drive and unscrew the screw member 20 that is worn and rounded.

4. The main body 10 is rotated clockwise to screw the screw member 20 by a large area contact of the second face 122. Alternatively, the main body 10 is rotated counterclockwise to unscrew the screw member 20 by a large area contact of the third face 123. Alternatively, the main body 10 is rotated counterclockwise to unscrew the worn screw member 20 by a force concentration of the second intersection point 125. Thus, the mounting element 11 has three rotational modes to drive and rotate the screw member 20.

5. Each of the six receiving portions 13 is an arcuate concave face. Each of the six receiving portions 13 is arranged between the second face 122 of one of the six drive portions 12 and the third face 123 of another one of the six drive portions 12. Each of the six receiving portions 13 is formed with a first arc 131. The first arc 131 is not tangent to the second face 122 and the third face 123. Thus, when the main body 10 is rotated to drive the screw member 20, each of the six angled corners of the screw member 20 is received in each of the six receiving portions 13, thereby preventing each of the six angled corners of the screw member 20 from being worn out.

6. Each of the first face 121, the second face 122, and the third face 123 has a planar shape, so that the first face 121, the second face 122, and the third face 123 will not cause a bite mark (or serration) on the screw member 20 during rotation.

7. In practice, the mounting element 11 includes more than twenty metric specifications and more than twenty British specifications, so that it will take too much time to design the sizes and specifications of the mounting element 11. In the engaging structure for a hand tool of the present invention, the second distance 127 is one twentieth of the first distance 126, and the first radius 132 is one tenth of the first distance 126. The mathematic expressions of the mounting element 11 are built in a software. Thus, after the value of the first distance 126 is designed and finished, the values of the second distance 127 and the first radius 132 are also determined, without having to design the variables of each of the specifications of the mounting element 11, thereby greatly decreasing the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A engaging structure for a hand tool, comprising:
a main body;
wherein:
the main body is provided with a mounting element;
the mounting element includes six drive portions and six receiving portions;
the six drive portions and the six receiving portions are arranged alternately and annularly;
each of the six drive portions includes a first face, a second face, and a third face;
the first face is arranged between the second face and the third face;
each of the first face, the second face, and the third face has a planar shape;
a first intersection point is located at an intersection of the first face and the second face;
a second intersection point is located at an intersection of the first face and the third face;
a first distance is defined between two parallel first faces;
a second distance is equal to a length of the first face;
the second distance is defined between the first intersection point and the second intersection point;
the second distance is one twentieth of the first distance;
each of the six receiving portions is an arcuate concave face;
each of the six receiving portions is arranged between the second face of one of the six drive portions and the third face of another one of the six drive portions;
each of the six receiving portions is formed with a first arc;
the first arc is not tangent to the second face;
the first arc is not tangent to the third face;
the first arc has a first radius which is one tenth of the first distance and is two times of the second distance;
the mounting element has an axis provided with a first center which constructs a first circle;
the first face of each of the six drive portions is tangent to the first circle;
the first circle forms a first hexagon having six sides;
the first face of each of the six drive portions coincides with each of the six sides of the first hexagon;
the first center is provided with a first vertical line;
the first vertical line passes through the first intersection point;
the first face and the third face are located at a first side of the first vertical line, and the second face is located at a second side of the first vertical line;
the first hexagon has six first angled corners;
the first arc of each of the six receiving portions is situated outside of each of the six first angled corners;
a first angle is defined between each of the six sides of the first hexagon and the second face;
the first angle is ranged between four degrees and five degrees;
a second angle is defined between each of the six sides of the first hexagon and the third face;
the second angle is more than the first angle;
the value of the second angle minus that of the first angle is ranged between 0.5 and 1.5;
the value of the second angle minus that of the first angle is ranged between 1.0 and 1.5;
the main body is used to rotate a screw member having six sides and six angled corners;
when the main body is rotated clockwise to drive the screw member, the second face of each of the six drive portions rests on each of the six sides of the screw member, a space is defined between the third face of each of the six drive portions and each of the six sides of the screw member, and each of the six angled corners of the screw member is received in each of the six receiving portions;
when the main body is rotated clockwise relative to the screw member, each of the six receiving portions is spaced from each of the six angled corners of the screw member, to prevent each of the six angled corners of the screw member from being worn;
when the main body is rotated counterclockwise to drive the screw member, the third face of each of the six drive portions rests on each of the six sides of the screw member, a space is defined between the second face of each of the six drive portions and each of the six sides of the screw member, and each of the six angled corners of the screw member is received in each of the six receiving portions;
when the main body is rotated counterclockwise relative to the screw member, each of the six receiving portions is spaced from each of the six angled corners of the screw member, to prevent each of the six angled corners of the screw member from being worn;
when the screw member is worn out and rounded and when the main body is rotated counterclockwise to drive the screw member, the third face and the second intersection point of each of the six drive portions rest on each of the six sides of the screw member;
the second intersection point has a linear contact with and concentrates a force on the screw member to drive the screw member; and
the mounting element is used to drive and rotate the screw member that is worn.

2. The engaging structure for a hand tool as claimed in claim 1, wherein the main body is a box end wrench or an engaging member of a hand tool.

3. The engaging structure for a hand tool as claimed in claim 1, wherein the main body is a ratchet wheel structure or a socket structure.

4. The engaging structure for a hand tool as claimed in claim 1, wherein the main body is a sliding rod structure, a float connector, a universal connector or a T-shaped universal connector.

5. The engaging structure for a hand tool as claimed in claim 1, wherein:
a fillet is formed between each of the six receiving portions and the second face of each of the six drive portions, so that each of the six receiving portions and the second face of each of the six drive portions are connected smoothly; and
a fillet is formed between each of the six receiving portions and the third face of each of the six drive portions, so that each of the six receiving portions and the third face of each of the six drive portions are connected smoothly.

6. The engaging structure for a hand tool as claimed in claim 1, wherein the second distance is one tenth of the first distance, and the first radius is equal to the second distance.
